(19) United States
(12) Patent Application Publication
(10) Pub. No.: US 2026/0039232 A1
(43) Pub. Date: Feb. 5, 2026

(54) METHOD AND APPARATUS FOR RAW SENSOR ERROR COMPENSATION

(71) Applicant: BorgWarner Inc., Auburn Hills, MI (US)

(72) Inventors: Caleb Wayne Secrest, Noblesville, IN (US); Travis Michael Mahnke, Noblesville, IN (US); Siddharth Ballal, Fishers, IN (US)

(21) Appl. No.: 18/788,555

(22) Filed: Jul. 30, 2024

(51) Int. Cl. H02P 29/024; H02P 21/00; H02P 21/18; H02P 21/22

(52) U.S. Cl. CPC H02P 29/024; H02P 21/0014; H02P 21/18; H02P 21/22

(57) ABSTRACT

Examples described herein provide a system that includes a controller operable to execute controller operations that include processing raw sensor output (RSO) to generate an error-compensated version of the RSO; and generating state information based at least in part on the error-compensated version of the RSO. The state information is operable to convey a state of a target.

### BACKGROUND OF THE INVENTION

Exemplary embodiments pertain in general to the art of electronic control units (ECUs), related circuitry and controller-implemented methods operable to compensate sensor output errors.

Electronic control units (ECUs) (or controllers) run processes that control behavior, monitor behavior, relay behavior information, and/or perform computations associated with various electronic and/or electro-mechanical systems. An ECU connected to a sensor typically receives sensor output information in its raw form. A sensor detects (i.e., senses) a detectable state of (or a detectable state associated with) a target object then generates raw sensor output (RSO) information/data that represents the detectable state of the target object. Although RSO information/data represents its associated detectable state, its native format does not actually convey the detectable state itself. In other words, RSO data is considered “raw” in that its “native” variable format (e.g., analog and/or digital representations of sine and cosine waves from a position sensor) has not been converted to a variable format (e.g., digital representations of angular position measured in radians and/or degrees) that can be read and understood by a user, or that can be used by an ECU to perform various controlling, monitoring, and/or information relaying operations.

Rotary systems, such as electric motors/generators (i.e., electric machines), that are employed as prime movers in a motor vehicle include a rotor that rotates about an axis of rotation. In some situations, the rotary system employs an ECU to receive RSO from one or more position sensors. The ECU converts the RSO from its native variable format to the angular position of the rotor and uses the computed angular rotor position to relay information, monitor performance, and or control the performance of the electric motor.

Position sensors typically generate RSO in native variable formats (e.g., sine/cosine outputs) and have specific non-ideal properties that cause angular error(s). The angular error(s) degrade overall system control by creating torque/power ripple that results in so-called noise, vibration, and harshness (NVH) conditions. Accordingly, ECUs that process error containing RSO conventionally include some form of error compensation.

### BRIEF DESCRIPTION OF THE INVENTION

Exemplary embodiments of the disclosure are directed to programmable computers, related circuitry, and/or computer-implemented methods operable to apply error compensation to uncompensated RSO before the uncompensated RSO is converted from a “native variable format” to a “converted variable format” that can be read and understood by a user. The “converted variable format” can also be used by a controller/ECU to perform various controlling, monitoring, and/or information relaying operations.

A non-limiting example of a system embodying aspects of the disclosure include a controller operable to execute controller operations that include processing RSO to generate an error-compensated version of the uncompensated RSO; and generating state information based at least in part on the error-compensated version of the RSO. The state information is operable to convey a state of a target.

Embodiments of the disclosure are also directed to a system operable to include a controller. The controller is operable to execute controller operations that include processing RSO to generate an error-compensated version of the RSO; and generating state information based at least in part on the error-compensated version of the RSO. Processing the RSO includes learning aspects of error in the RSO. The state information is operable to convey an angular position of a rotor of a motor.

Embodiments of the disclosure are also directed to methods of forming, methods of using, and computer program products operable to implement any one or more of the above-described systems.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The following descriptions should not be considered limiting in any way. With reference to the accompanying drawings, like elements are numbered alike:

FIG. 1A is a simplified block diagram illustrating a system in accordance with embodiments of the disclosure;

FIG. 1B is a simplified block diagram illustrating a non-limiting example of how portions of the system shown in FIG. 1A can be implemented in accordance with embodiments of the disclosure;

FIG. 2 is a simplified block diagram illustrating a smart sensor in accordance with embodiments of the disclosure;

FIG. 3 depicts functions representing uncompensated raw sensor output (RSO), functions representing compensated RSO, and definitions of variables used in FIGS. 4-8 in accordance with embodiments of the disclosure;

FIG. 4 is a simplified block diagram illustrating a non-limiting example of how the system shown in FIG. 1A can be implemented in accordance with embodiments of the disclosure;

FIG. 5 is a simplified block diagram illustrating a non-limiting example of how the system shown in FIG. 2 can be implemented in accordance with embodiments of the disclosure;

FIG. 6 is a simplified block diagram illustrating a non-limiting example of how the raw sensor output (RSO) error compensation module of the system shown in FIGS. 1A-1D can be implemented in accordance with embodiments of the disclosure;

FIG. 7A is a detailed block diagram illustrating a non-limiting example of how the raw sensor output (RSO) error compensation module shown in FIG. 6 can be implemented in accordance with embodiments of the disclosure;

FIG. 7B is a detailed block diagram illustrating a non-limiting example of how the raw sensor output (RSO) error compensation module shown in FIG. 6 can be implemented in accordance with embodiments of the disclosure;

FIG. 7C is a detailed block diagram illustrating a non-limiting example of how the raw sensor output (RSO) error compensation module shown in FIG. 6 can be implemented in accordance with embodiments of the disclosure;

FIG. 7D is a detailed block diagram illustrating a non-limiting example of how the raw sensor output (RSO) error compensation module shown in FIG. 6 can be implemented in accordance with embodiments of the disclosure;

FIG. 8 depicts plots illustrating how the systems shown in FIGS. 1A, 1B, 2, and 4-7D learn (or converge to) a plurality of RSO-error contributing factors in chunks and over time in accordance with embodiments of the disclosure; and

FIG. 9 is a simplified block diagram illustrating a computing system operable to implement embodiments of the disclosure.

### DETAILED DESCRIPTION OF THE INVENTION

A detailed description of one or more embodiments of the disclosed apparatus and method are presented herein by way of exemplification and not limitation with reference to the figures. In particular, embodiments described herein provide a computationally efficient approach to compensate sensor error components over a wide speed operating range of a rotary system or electric machine.

As previously noted herein, position sensors generate RSO in native variable formats (e.g., sine/cosine outputs) and have specific non-ideal properties that cause angular error(s). The angular error(s) degrade overall system control by creating torque/power ripple that results in so-called noise, vibration, and harshness (NVH) conditions. Accordingly, ECUs (or controllers) that process error containing RSO conventionally include some form of error compensation. However, known sensor error compensation techniques compensate errors in uncompensated state information (e.g., angular position data) computed from error containing RSOs (e.g., sine/cosine position sensor outputs). In other words, known sensor compensation techniques convert error containing RSO to state information, then attempt to remove error from the computed state information.

Embodiments of the disclosure provide programmable computers, related circuitry and computer-implemented methods operable to implement error compensation functionality and associated state computation functionality in electronic systems that perform sensor-based control operations. The error compensation functionality is configured and arranged to apply error compensation to uncompensated, not-yet-converted raw sensor outputs (RSOs). As used herein, the terms “uncompensated RSO” refer to RSO to which error compensation has not been applied. In accordance with aspects of the disclosure, the error compensation is applied before the RSO is converted from its native variable formats (e.g., analog and/or digital representations of sine and cosine waves generated by a position sensor) to a converted/different variable format (e.g., digital representations of an angular position measured in radians and/or degrees). In accordance with aspects of the disclosure, the RSO represents a detectable phenomenon associated with a target object, including, for example, a detectable state of the target object (e.g., position, temperature, pressure, etc.) of the target object.

In accordance with aspects of the disclosure, raw sensor output (RSO) is generated in a “variable format” that is native to the sensor that generates the RSO. In some embodiments of the disclosure, the native variable format can be implemented as a measurement unit that is native to the sensor that generates the RSO. As used herein, the terms “unit of measurement,” “unit of measure,” “measurement units,” and equivalents thereof are a definite magnitude of a quantity, defined and adopted by convention or by law, that is used as a standard for measurement of the same kind of quantity. Any other quantity of that kind can be expressed as a multiple of the unit of measurement. For example, a length is a physical quantity. The meter (symbol m) is a unit of length that represents a definite predetermined length. For instance, when referencing “10 meters” (or 10 m), what is actually meant is 10 times the definite predetermined length called “meter.” Metrology is the science of developing nationally and internationally accepted units of measurement, and the definition, agreement, and practical use of units of measurement is conveyed through a global standard, the International System of Units (SI), which is the modern form of the metric system.

As an example, a transistor-based biosensor generates RSO as current, which has a native variable format that includes a unit of measure. The unit of measure for current is amperes. Transistor-based biosensors can be configured to measure various types of physical and chemical parameters. In a known biosensor configuration, a field effect transistor (FET) acts as a transducer separated by an insulator layer (e.g. SiO₂) from a biological recognition element (a.k.a., a biosensor electrode). The recognition element can be a biofilm material such as a receptor, enzyme, antibody, DNA or other type of capturing molecule that is biologically specific for the target analyte. The recognition element can be configured to detect, for example, ion concentration (e.g., pH) or the concentration of target biomolecules (e.g., DNA, microRNA, enzymes, antibodies, and the like). Other types of transducers can be used to convert the detection of the analyte to other types of measurable outputs such as optical signals, physiochemical signals, piezoelectric signals, electrochemical signals, and the like.

In the transistor-based implementation of a biosensor, once the targeted ions and/or molecules bind to the recognition element, the charge distribution at the surface of the recognition element changes, which causes a corresponding change in the electrostatic surface potential at a gate of the FET. This change in the surface potential applies a voltage to the FET's gate, which results in a voltage drop (Vgs) across the gate and the source. When the applied gate voltage causes Vgs to reach the threshold voltage (Vth), current starts to flow from the source to the drain. The Vth is defined as the value of Vgs at which a sufficient density of mobile electrons or holes gather in the channel to allow the channel to conduct. The value of Vgs and the resulting source to drain current flow are in the native measurement units of the biosensor. Although these native measurement units (voltage and amperes) are proportional to the targeted ions and/or molecules that were recognized by the recognition element, the native measurement units do not convey to a user or a downstream processing system the targeted ions and/or molecules that were recognized by the recognition element.

The native measurement units of the FET element of the biosensor (i.e., current or conductance) can be measured and analyzed to convert the native measurements units in amperes (i.e., the native variable format) of the RSO to a “converted variable format” that conveys to a user or downstream analysis systems the analyte that is binding to the biological recognition element. In this example, the “converted variable format” can be the name of the targeted ions and/or molecules that were recognized by the recognition element. In this example, the “converted variable format” can also be the name of the targeted ions and/or molecules that were recognized by the recognition element, along with a measurement unit that conveys an amount of the targeted ions and/or molecules that were recognized by the recognition element.

For the sake of brevity, conventional techniques related to making and using aspects of the disclosure may or may not be described in detail herein. In particular, various aspects of controllers, computing systems and specific computer programs to implement the various technical features described herein are well known. Accordingly, in the interest of brevity, many conventional implementation details are only mentioned briefly herein or are omitted entirely without providing the well-known system and/or process details.

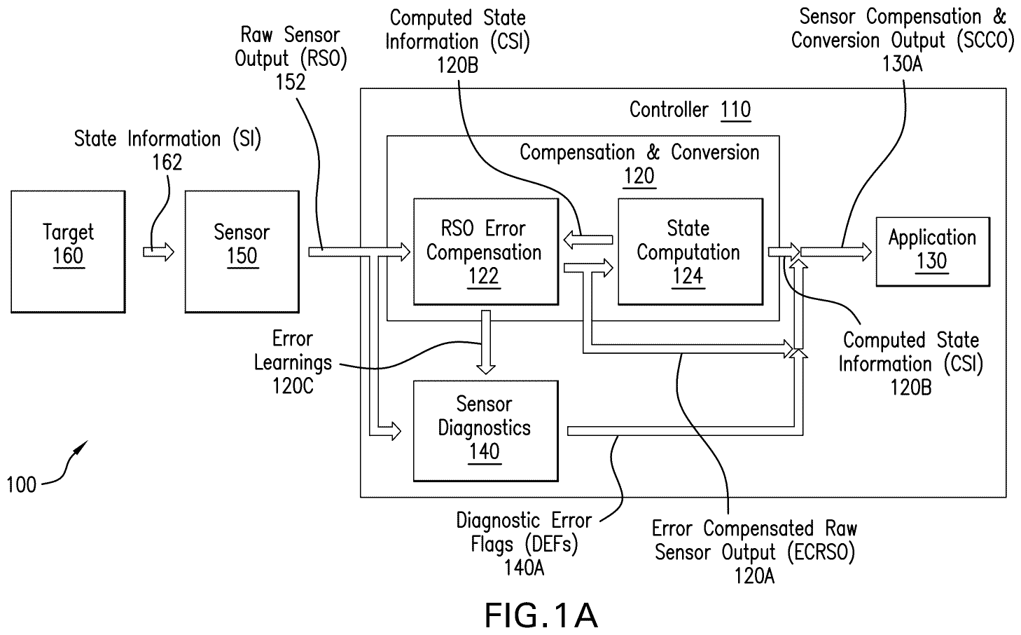

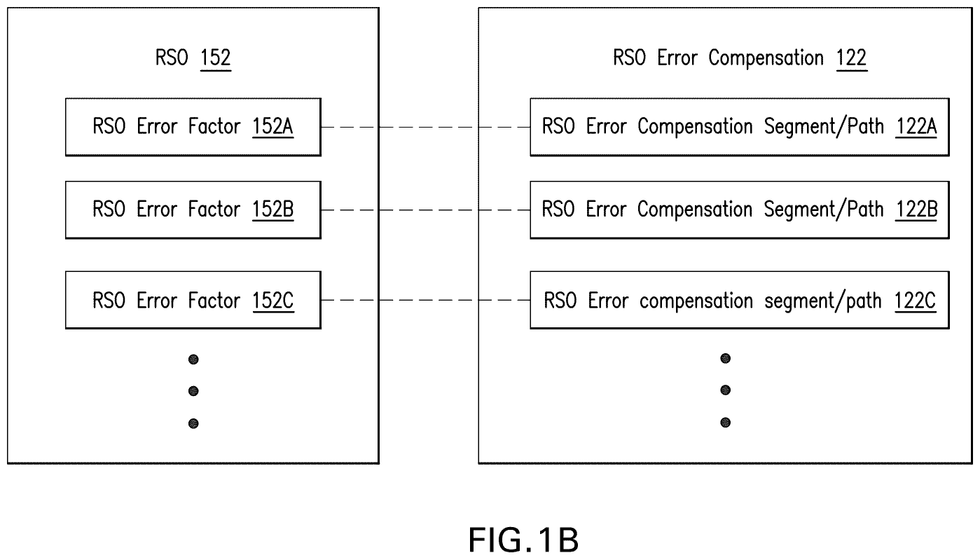

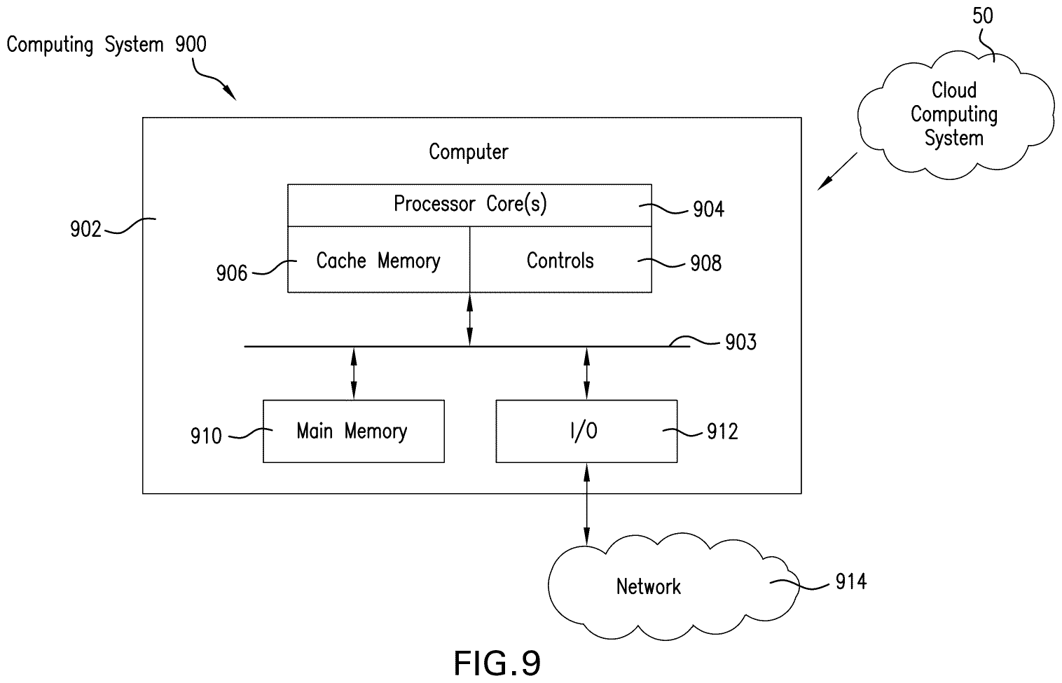

FIG. 1A is a simplified block diagram illustrating an electronic system 100 in accordance with embodiments of the disclosure. The system 100 includes a controller 110, which is in wired or wireless electronic communication with a sensor 150 and a target 160. The controller 110 includes a compensation & conversion (C&C) module 120, a sensor diagnostic module 140, and an application module 130, configured and arranged as shown. The C&C module 120 includes RSO error compensation functionality 122 and state computation functionality 124. The controller 110 can be implemented as an ECU, and both the controller 110 and the ECU can be implemented as a computer system 900 (shown in FIG. 9). The target 160 can be any object or environment having detectable phenomena (e.g., temperature, location, speed, angular position, and the like) associated therewith. In some embodiments of the disclosure, the target 160 can be implemented as a rotary system, such as an electric motor/generator (i.e., an electric machine), that is employed as a prime mover in a motor vehicle. The motor implementation of the target 160 can include a rotor that rotates about an axis of rotation. In some situations, such a rotary system employs the controller/ECU 110 to receive RSO 152 from the sensor 150. The sensor 150 can be any suitable arrangement of one or more sensing devices, including, for example, electronic sensors, mechanical sensors, chemical sensors, biosensors, and the like. Such sensing devices detect and respond to some type of input from the physical environment. The input to the sensor 160 can be light, heat, motion, moisture, pressure or any number of other environmental phenomena.

In some embodiments of the disclosure, the sensor 150 can be implemented as one or more sensing devices having non-ideal properties. The sensor 150 is configured to detect or sense environmental phenomena, including, for example, a detectable phenomenon (e.g., state information 162) associated with the target 160. Responsive to detecting the detectable phenomena, the sensor 150 generates RSO data/information 152 also associated with the target 160. In general, the RSO data 152 is “raw” in that it is in its native variable formats (e.g., analog and/or digital representations of sine and cosine waves from a position sensor) and has not been converted to a converted variable format (e.g., digital representations of angular position measured in radians and/or degrees) that can be used by the controller 110 to perform various controlling, monitoring, and/or information relaying operations. Because the sensor 150 has non-ideal properties, the RSO data 152 includes one or more RSO-error contributing factors (or one or more RSO-error factors), and the RSO data 152 is uncompensated in that the RSO-error contributing factor(s) of the RSO data 152 have not been removed or otherwise compensated.

In accordance with aspects of the disclosure, the controller 110 reads, receives, or otherwise accesses the uncompensated RSO data 152 in its native variable format and applies the same to the C&C module 120. In contrast to known error compensation techniques that compensate errors in state information/data computed from error containing RSO (e.g., RSO data 152), the C&C module 120 executes a novel RSO error compensation functionality 122 that is applied by the C&C module 120 to the uncompensated RSO 152. The outputs of the C&C module 120 include error-compensated versions of the uncompensated RSO 152, which are represented in FIG. 1A as error-compensated RSO (ECRSO) data 120A. Similarly, the C&C module 120 executes state computation functionality 124 that computes or calculates, based at least in part on ECRSO 120A, computed state information (CIS) 120B. Additionally, the C&C module 120, as part of performing the RSO error compensation functionality 122, learns aspects of the error in the uncompensated RSO 152 and outputs error learnings 120C, which represent the learned aspects of the error in the uncompensated RSO. The error-learnings 120C are provided to a sensor diagnostics module 140, which computes or calculates diagnostic data or diagnostic error flags (DEFs) 140A based at least in part on the error learnings 120C. In some embodiments of the disclosure, the sensor diagnostics module 140 can compute or calculate the diagnostic data or DEFs 140A based at least in part on the uncompensated RSO 152 and the error learnings 120C. The DEFs 140A are operable to identify a source or cause or origin of the error learnings 120C. For example, in some embodiments of the disclosure, a first DEF 140A can be configured to represent/identify a fault condition in the sensor 150, and a second DEF 140A can be configured to represent/identify an out-of-tolerance condition in the sensor 150. The application module 130 uses some or all of the outputs from the C&C module 120 and/or the sensor diagnostics module 140 to perform various tasks, including but not limited to control tasks associated with the target 160.

In accordance with embodiments of the disclosure, because the C&C module 120 is applied to uncompensated RSO data 152, errors in the uncompensated RSO data 152 are analyzed at the source rather than following known compensation approaches that analyze RSO-originated errors after the RSO data 152 and its accompanying errors have been converted to another form (e.g., state information/data computed from error-containing RSO data). Analyzing errors in the uncompensated RSO data 152 enables the C&C module 120 to be constructed in an efficient manner that provides technical effects. For example, as depicted in FIG. 1B, the uncompensated RSO data 152 can be multivariate and configured to include multiple uncompensated RSO-error contributing factors, three (3) examples of which are shown in FIG. 1B as RSO-error contributing factors 152A, 152B, 152C. Embodiments of the disclosure segment the RSO error compensation functionality 122 to provide multiple RSO error compensation segments/paths, three (3) examples of which are shown in FIG. 1B as RSO error compensation segments/paths 122A, 122B, 122C. RSO error compensation segments/paths 122A, 122B, 122C are each configured and arranged to compensate error associated with a particular corresponding one of the uncompensated RSO-error contributing factors 152A, 152B, 152C.

In embodiments of the disclosure, each RSO error compensation segment/path can be implemented as feedback-based learning functionality/methodology that, in effect, learns the error associated with its corresponding or assigned uncompensated RSO-error contributing factor in portions and over time. In some embodiments of the disclosure, the controller 110 does not learn all of the error but instead learns a piece of it. The controller 110 applies correction based upon that piece of learned error. This process repeats until the controller 110 fully learns and compensates the error.

In some embodiments of the disclosure, each RSO error compensation segment/path 122A, 122B, 122C can be designed or controlled or tuned to optimize its error identification functions based at least in part on how the particular implementation of the sensor 150 generates its uncompensated RSO-error contributing factor 152A, 152B, 152C over time. For example, an implementation of the sensor 150 can be analyzed and provided with a suite of RSO-error contributing factors (e.g., RSO-error contributing factors 152A, 152B, 152C) designed or controlled or tuned to optimize their error identification functions based at least in part on how the particular implementation of the sensor 150 generates its uncompensated RSO-error contributing factor. In some embodiments of the disclosure, each RSO error compensation segment/path 122A, 122B, 122C can be controlled or tuned to optimize its error identification functions based at least in part on real time analysis (e.g., as performed by the controller 110) of how the particular type of the sensor 150 is generating its uncompensated RSO-error contributing factors 152A, 152B, 152C.

Additionally, each RSO error compensation segment/path 122A, 122B, 122C can be designed or controlled or tuned to reduce or optimize the time the RSO error compensation segment/path takes to learn the error in its corresponding or assigned uncompensated RSO-error contributing factor (e.g., RSO-error contributing factors 152A, 152B, 152C. For example, where RSO error compensation segments/paths 122A, 122C each takes longer to learn its corresponding error than the RSO error compensation segment/path 122B takes to learn its corresponding error, each of the RSO error compensation segments/paths 122A, 122C can be designed or controlled or tuned to reduce or optimize the time the RSO error compensation segment/path takes to learn the error in its corresponding or assigned uncompensated RSO-error contributing factor.

Additionally, as depicted in FIG. 1B, the RSO error compensation segments/paths 122A, 122B, 122C enable the controller 110 to apply diagnostic analysis to the errors and error types in the RSO-error contributing factors 152A, 152B, 152C. For example, the RSO error compensation segments/paths 122A, 122B, 122C can each generate error learnings 120C (shown in FIG. 1A) that are provided to the sensor diagnostics module 140 for analysis. If, for example, it is known that a magnitude of the error in the RSO-error contributing factor 152A below a threshold is associated with an out-of-tolerance condition of the sensor 150, while a magnitude of the error in the RSO-error contributing factor 152A above a threshold is associated with a fault condition of the sensor 150, the magnitude of the error in the RSO-error contributing factor 152A can be included as part of the error learnings 120C and provided to the sensor diagnostics module 140 for a determination of whether the sensor 150 is experiencing an out-of-tolerance condition or a fault condition. Based at least in part on the results of its diagnostic analysis, the sensor diagnostics module 140 can initiate the generation (e.g., by the controller 110 or another automated system) of a notification that the sensor 150 is experiencing an out-of-tolerance condition but the out-of-tolerance condition has been corrected by the C&C module 120. Similarly, based at least in part on the results of its diagnostic analysis, the sensor diagnostics module 140 can initiate the generation (e.g., by the controller 110 or another automated system) of a notification that the sensor 150 is experiencing a fault condition and the sensor 150 needs to be repaired or replaced.

The various components/modules/functionalities of the system 100 illustrated in FIG. 1A are configured and arranged as depicted for ease of illustration and explanation. In embodiments of the disclosure, the operations performed by the various components/modules/functionalities can be distributed differently than shown without departing from the scope of the various embodiments of the disclosure described herein unless it is specifically stated otherwise. For example, in some embodiments of the disclosure, the sensor 150 can be provided as a component of the controller 110. In some embodiments of the disclosure, the controller 110 can be implemented as a configuration of distributed and connected controllers, where controller functionality is provided at various locations throughout the system (e.g., at the sensor 150, at the sensor diagnostic module 140, at the application 130, and the like), and where the operations and functionality of the controller 110 are also distributed among the distributed, connected controllers in any combination. Other configurations of the components that make up the system 100 are also contemplated.

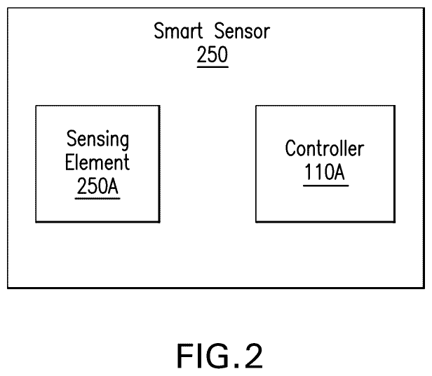

FIG. 2 is a simplified block diagram illustrating how the sensor 150 (shown in FIG. 1A) can be implemented as a smart sensor 250 that includes a sensing element 250A and a controller 210A. The adjectives “smart” and/or “connected” are often used to describe the use of computer-based, networked technologies to augment the features of a product or a system. Smart/connected products are embedded with processors, sensors, software, and connectivity that allow data about the product to be gathered, processed, and transmitted to external systems. The data collected from smart/connected products can be analyzed and used to inform decision-making and enable operational efficiencies of the product. The controller 210A can include some or all of the functions/operations performed by the controller 110 in any combination. The sensing element 250A is in wired or wireless communication with the controller 110A. The smart sensor 250 operates as an Internet of Things (IoT) sensing device, and the sensing element 250A has substantially the same functionality as the sensor 150. The controller 110A is also in wired or wireless electronic communication with the target 160 (shown in FIG. 1A). The controllers 110, 110A can be implemented as a computer system 900 (shown in FIG. 9).

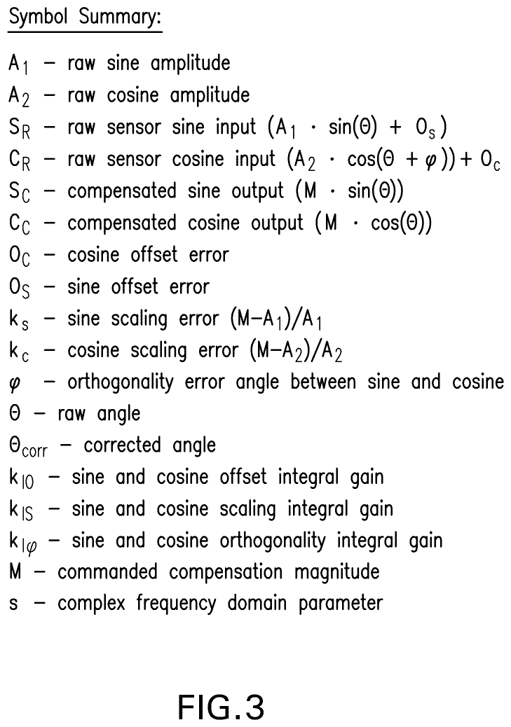

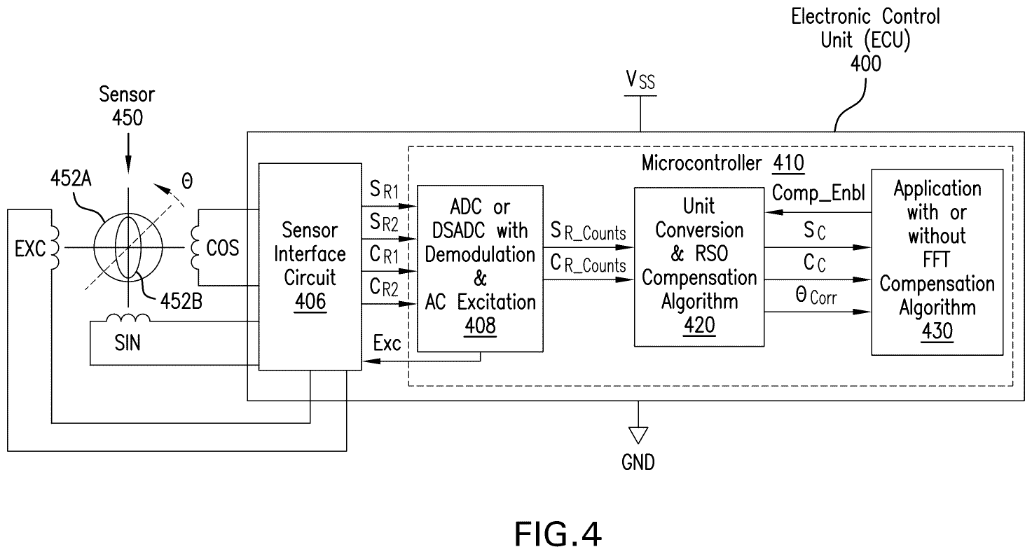

FIG. 3 depicts functions representing uncompensated sine and cosine RSO, along with additional definitions of variables used in an electronic control unit (ECU) 400, smart sensor 550, and RSO algorithms 420-420B depicted in FIGS. 4-7D in accordance with embodiments of the disclosure. These functions and additional definitions will be referenced when describing the ECU 400, smart sensor 550, and RSO algorithms 420-420B depicted in FIGS. 4-7D.

FIG. 4 is a simplified block diagram illustrating a non-limiting example of how an error compensation system can be implemented in accordance with aspects of the invention. More specifically, the controller 110 and the sensor 150 shown in FIG. 1A can be implemented as the ECU 400 operable to interface with a position sensor 450 shown in FIG. 4. Similar to the controller 110, the ECU 400 also interfaces with the target 160 (shown in FIG. 1A) and the sensor diagnostics module 140 (shown in FIG. 1A). The ECU 400 includes a sensor interface circuit 406 and a microcontroller 410. In embodiments of the disclosure, the microcontroller 410 can be any suitable circuit, including the computing system 900 (shown in FIG. 9), a FPGA (field programmable gate array), a CPLD (complex programmable logic device), an ASIC (application-specific integrated circuit), and the like. The microcontroller 410 corresponds to and includes all of the features and functionality of the controller 110 shown in FIG. 1A. The microcontroller 410 provides additional non-limiting details of how the some or all of the features and functionality of the controller 110 can be implemented in accordance with aspects of the disclosure. As shown in FIG. 4, the microcontroller 410 includes an ADC (analog-to-digital converter) or DSADC (delta-sigma analog-to-digital converter) module 408, which also provides demodulation and AC (alternating current) excitation; a unit conversion & RSO compensation algorithm 420; and an application algorithm 430, which can be with or without FFT (fast Fourier transform) compensation.

With respect to the ECU 400, the target/motor 160 (shown in FIG. 1A) can be implemented as an electric motor, such as an alternating current (AC) motor. The target/motor 160 can include a rotor coupled to a shaft. The rotor rotates about an axis of rotation in either a clockwise or counterclockwise direction. When rotating, the rotor causes the shaft to rotate about the axis of rotation. The shaft can be coupled to a device (not shown) to cause the device to receive torque from the motor via the shaft.

In the ECU 400, the sensor 450 can be implemented as a position sensor (e.g., a resolver). The sensor 450 will have non-ideal properties that result in errors being present in the outputs of the sensor 450. Additional errors can be introduced to sensor outputs by the sensor interface circuit 406. As previously noted herein, position sensors such as the position sensor 450 with sine/cosine outputs have specific non-ideal properties that cause angular error(s). The angular error(s) degrade overall system control by creating torque/power ripple that results in so-called noise, vibration, and harshness (NVH) conditions. Accordingly, ECUs that process error-containing sensor outputs conventionally include some form of error compensation. However, known controller error compensation techniques are designed to compensate errors in uncompensated target physical state (e.g., angular position data) computed from error-containing raw sensor outputs (e.g., sine/cosine position sensor outputs). In contrast to such known error compensation systems, embodiments of the disclosure provide electronic systems and associated computer-implemented methods that perform sensor-based control operations configured and arranged to apply error compensation directly to raw sensor outputs before the raw sensor outputs are converted from their native variable formats (e.g., analog and/or digital representations of sine and cosine waves from a position sensor) to a converted/different variable format (e.g., digital representations of an angular position measured in radians and/or degrees) that represents and/or conveys the state information of the target 160.

The sensor 450 includes a variable reluctance rotor 452B, and three (3) stationary coils (COS, SIN, EXC) 452A, where the stationary coil COS is electrically displaced 90° with SIN. EXC is either aligned with SIN or COS. Based on the current flow induced between EXC and the stationary coils COS, SIN by the applied alternating voltage through the excitation coils EXC, the sensor 450 generates signals that represent the outputs from the stationary coils SIN (SR1, SR2) and outputs from the stationary coils COS (CR1, CR2), which are passed through the sensor interface circuit 406 to the ADC or DSADC module 408, which also provides demodulation of the analog waves SR1, SR2, CR1, CR2. The sensor interface circuit 406 also generates the AC excitation signal (EXC) and passes it through the sensor interface circuit 406 to the excitation coils EXC. The ADC and/or the DSADC (with demodulation) module 408 performs any suitable analog-to-digital conversion process that converts a continuously variable, or analog, signal to into a multi-level digital signal without altering its essential content. More specifically, the ADC and/or DSADC module 408 converts the analog waves SR1, SR2, CR1, CR2 to demodulated digital pulse streams SR1_Counts (from the stationary coils COS) and CR1_Counts (from the stationary coils SIN). It should be noted that, although the ADC and/or DSADC module 408 converts the analog waves SR1, SR2, CR1, CR2 to demodulated digital pulse streams SR1_Counts (from the stationary coils COS) and CR1_Counts (from the stationary coils SIN), the demodulated digital plus streams are still considered raw data because the essential content (i.e., information) of the analog waves SR1, SR2, CR1, CR2 is not substantially changed in the demodulated digital pulse streams SR1_Counts (from the stationary coils COS) and CR1_Counts (from the stationary coils SIN).

The unit conversion & RSO compensation algorithm 420 corresponds to and includes the features and functionality of the C&C module 120 shown in FIG. 1A. The unit conversion & RSO compensation algorithm 420 also include unit conversion functionality. In general, a unit conversion is a process of converting a measurement value from one unit of measurement to another unit of measurement. For example, converting miles to kilometers, or inches to centimeters. Unit conversions are commonly used in science, engineering, and everyday life to convert between different units of measurement for the same physical quantity. For example, miles per hour can be converted to kilometers per hour to understand the speed of a car in a different country. Unit conversions can be done using conversion factors. A conversion factor is a ratio that relates two units of measurement and can be used to convert from one unit to another. For example, the conversion factor between miles and kilometers is 1 mile=1.609 kilometers. In embodiments of the disclosure, the unit conversion portion of the module in 420 takes SR1_Counts and CR1_Counts and converts the signals to be in units of volts whereas the RSO compensation algorithm portion of the module in 420 addresses the errors present in the signals SR1_Counts and CR1_Counts after unit conversion takes place. The RSO compensation algorithm accomplishes the error removal by learning compensation factors to be added or multiplied to the unit converted signals.

The unit conversion & RSO compensation algorithm 420, responsive to a compensation enable signal (Comp_Enbl), processes the uncompensated demodulated digital pulse streams SR1_Counts (from the stationary coils COS) and CR1_Counts (from the stationary coils SIN) to generate compensated sensor outputs Sc, Cc, and θcorr, which are provided to the application algorithm 430. As previously noted, the application algorithm 430 can be with or without FFT (fast Fourier transform) compensation. The application algorithm 430 corresponds to and includes all of the features and functionality of the application module 130 shown in FIGS. 1A and 2.

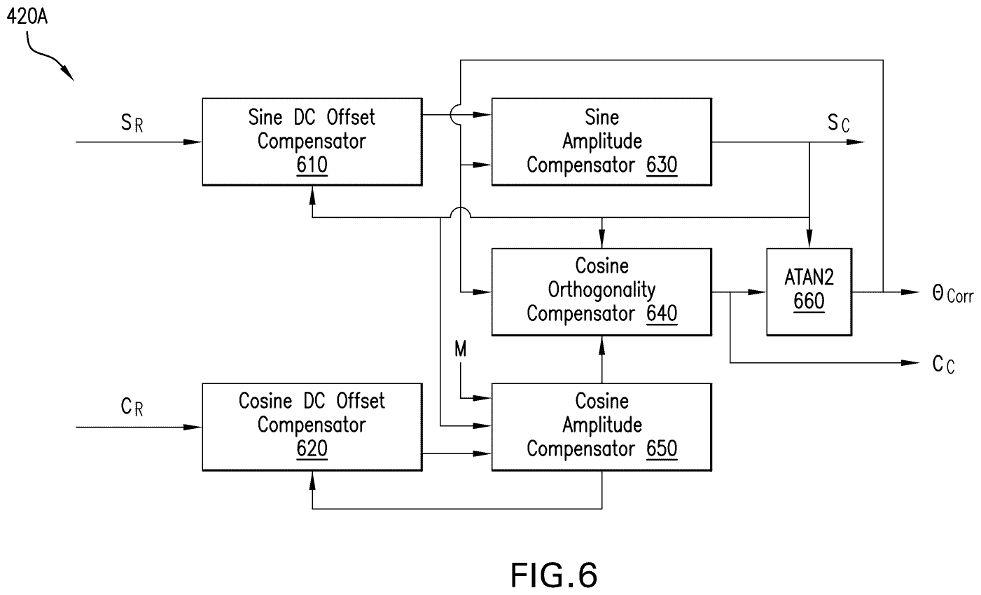

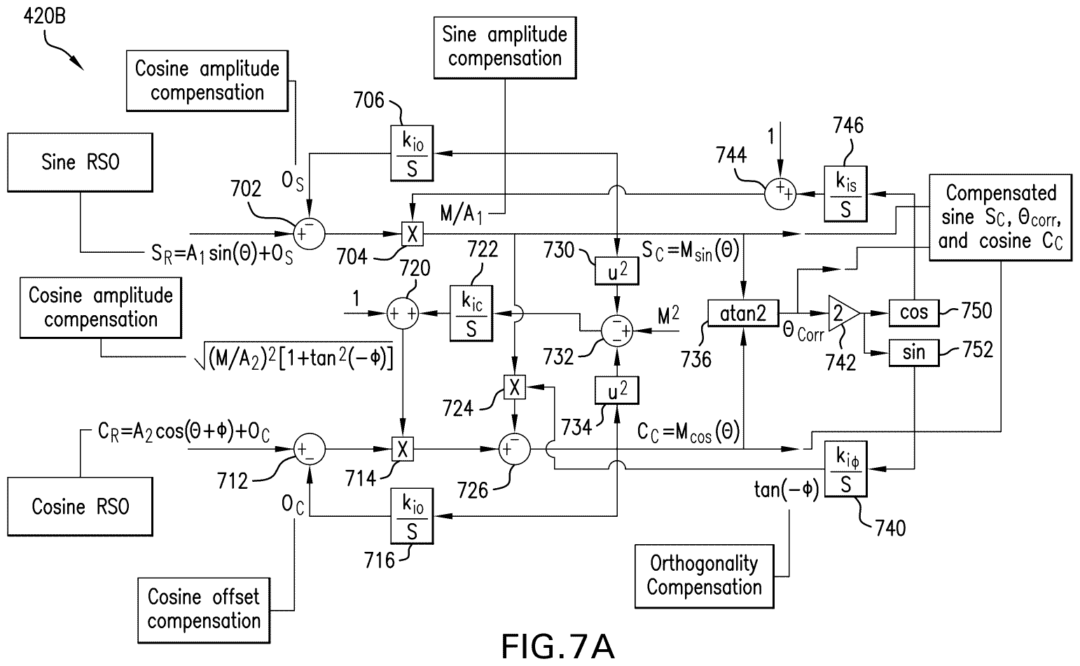

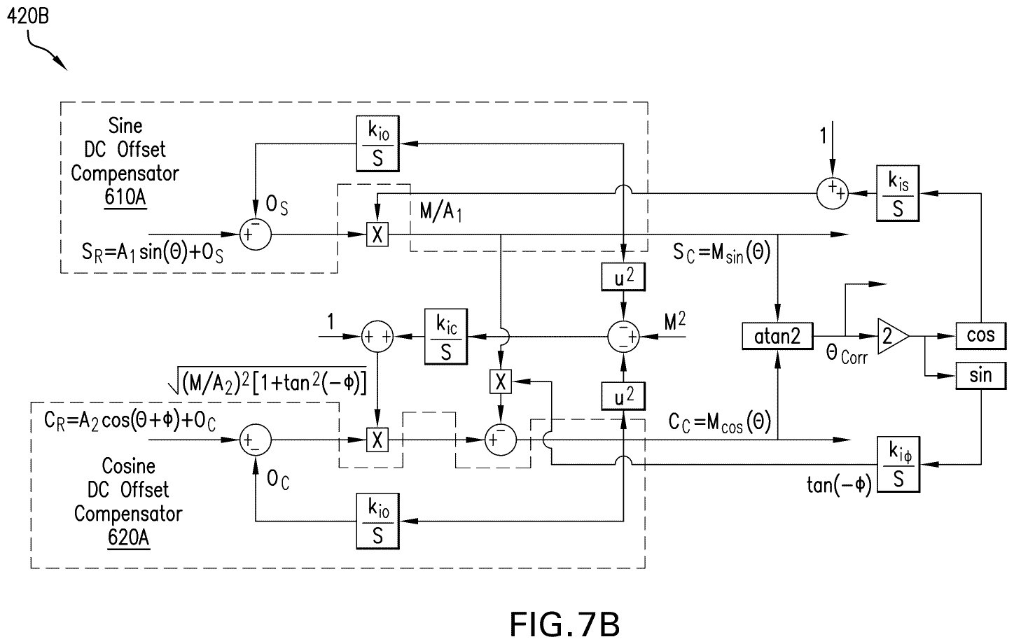

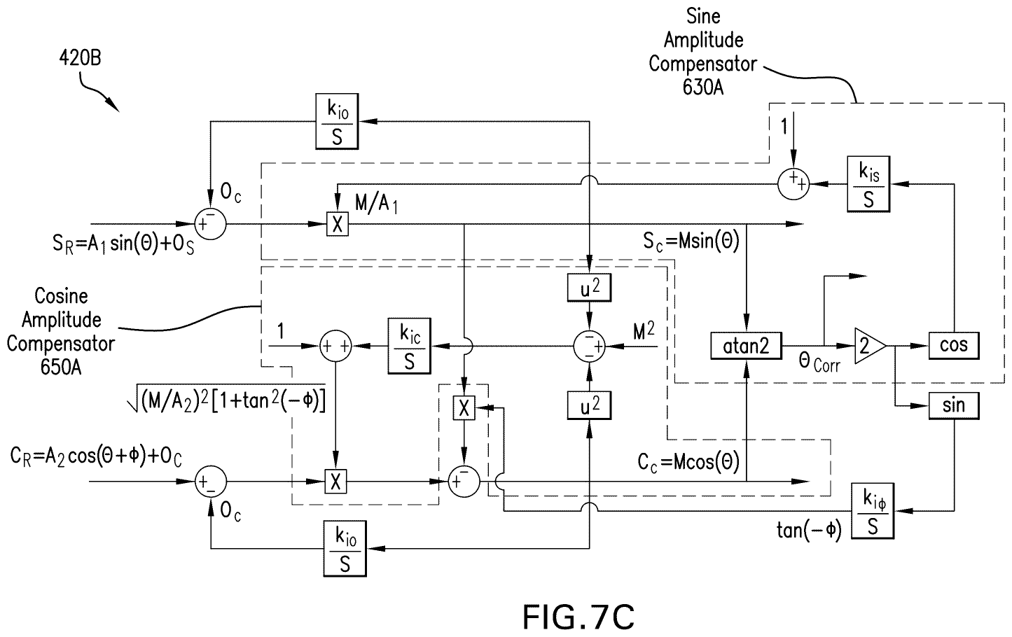

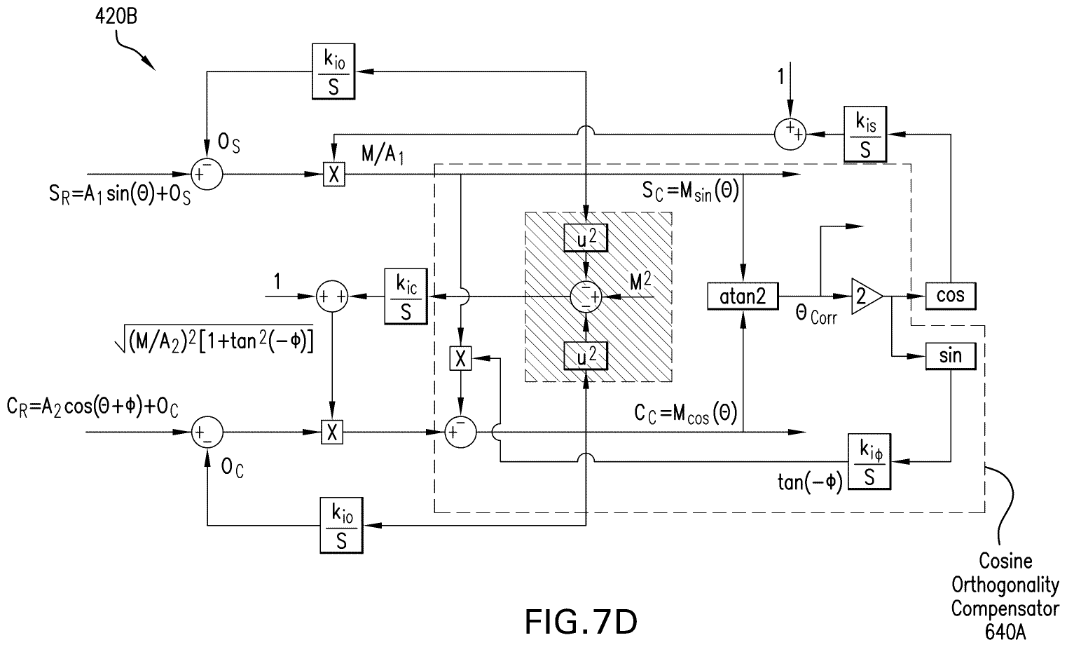

The unit conversion & RSO compensation algorithm 420, as well as the algorithm/architecture 420A (shown in FIG. 6), provides additional non-limiting details of how some or all of the features and functionality of the C&C module 120 can be implemented in accordance with aspects of the disclosure. The additional non-limiting details of how some or all of the features and functionality of the C&C module 120 can be implemented in accordance with aspects of the disclosure are provided below in connection with descriptions of the algorithms/architectures 420A, 420B (shown in FIGS. 6 and 7A-7D).

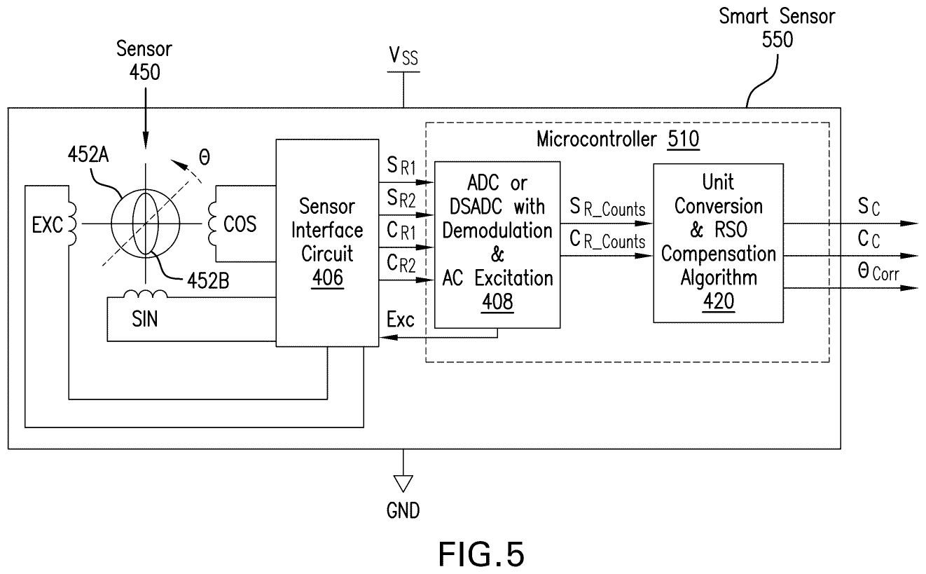

FIG. 5 is a simplified block diagram illustrating a smart sensor 550 in accordance with embodiments of the disclosure. The smart sensor 550 incorporates the sensor 450, sensor interface circuit 406 and a microcontroller 510 into a single IoT structure. The microcontroller 510 includes the ADC or DSADC module 408 and the unit conversion and RSO compensation algorithm 420. The smart sensor 550 is in wired or wireless communication with the application algorithm 430 (shown in FIG. 4), and the combination of the smart sensor 450 and the application algorithm 420 is in wired or wireless communication with the target 160 (shown in FIG. 1A) and the sensor diagnostics 140 (shown in FIG. 1A). Accordingly, the combination of the smart sensor 550, the application algorithm 430, the target 160, and the sensor diagnostics 140 is substantially identical in its overall functionality to the systems 100 and related components shown in FIG. 1A. Because the combination of the smart sensor 550, the application algorithm 430, the target 160, and the sensor diagnostics 140 is substantially identical in its overall functionality to the system 100 and related components shown in FIG. 1A, the overall functions performed by the smart sensor 550, the application algorithm 430, the target 160, and the sensor diagnostics 140 will not be repeated here.

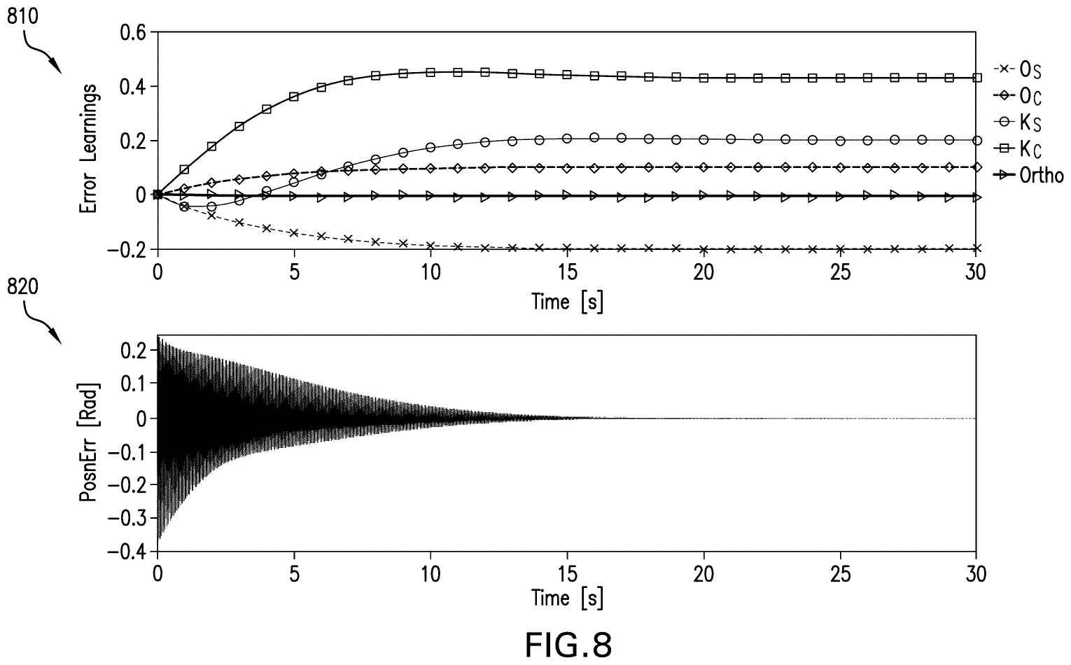

FIG. 6 is a simplified block diagram illustrating a non-limiting example of how the RSO compensation of the unit conversion & RSO compensation algorithm 420 (shown in FIG. 4) can be implemented as an RSO compensation algorithm 420A in accordance with embodiments of the disclosure. The RSO compensation algorithm 420A includes a sine DC offset compensator 610, a cosine DC offset compensator 620, a sine amplitude compensator 630, a cosine orthogonality compensator 640, a cosine amplitude compensator 650, and an A TAN 2 (“arc tangent of two numbers,” or “four-quadrant inverse tangent”) function/module 660, configured and arranged as shown. The RSO compensation algorithm 420A includes five (5) raw-error compensation mechanisms 610-650, along with the A TAN 2 function/module 660 connected in an integrated fashion to form an algorithm. In operation, the five (5) raw-error compensation mechanisms 610-650 of the RSO compensation algorithm 420A each operates as a learning function that, in effect, uses various feedback paths among the five (5) raw-error compensation mechanisms 610-650 to learn its associated raw-error compensation task. Each of the five (5) raw-error compensation mechanisms 610-650 performs repeated iterations of its raw-error compensation task taking into account previous raw-error compensation task results until the raw-error compensation task converges to a solution. Examples of how the five (5) raw-error compensation mechanisms 610-650 converge to raw error compensation solutions are depicted in graphs 810, 820, which are shown in FIG. 8 and described in greater detail subsequently herein.

The sine DC offset compensator 610 receives an uncompensated raw sine signal Sr and the fully compensated sine signal Sc, which is fed back to the DC offset compensator 610 by the sine amplitude compensator 630, thereby producing a sine signal with only DC offset corrected. An identical set of operations is performed within the cosine DC offset compensator 620. The cosine DC offset compensator 620 receives an uncompensated raw cosine signal Cr and the fully compensated cosine signal Cc, which is fed back to the cosine DC offset compensator 620 by the cosine amplitude compensator 650, thereby producing a cosine signal with only DC offset corrected.

The sine amplitude compensator 630 uses the sine signal with only DC offset corrected (generated by the sine DC offset compensator 610) and the corrected angle θcorr (generated by the A TAN 2 660) to generate a sine signal without DC offset error and amplitude error relative to the amplitude command M (i.e., compensated amplitude M). In general, an amplitude error condition is when the sine amplitude A1 is different from the cosine amplitude A1. The compensated amplitude M is used in the algorithm 420A as a normalization that compensates the A1/A2 sine/cosine amplitude error by, in effect, performing a normalization of A1 to M and performs a normalization of A2 to M. The cosine amplitude compensator 650 uses a different algorithm than the sine amplitude compensator 630, and thus the inputs to the cosine amplitude compensator 650 include the amplitude command M (i.e., compensated amplitude M), the fully compensated sine signal Sc, and cosine signal corrected only for DC offset (generated by the cosine DC offset compensator 620) to create a cosine signal without DC offset error and amplitude error relative to the amplitude command M (or compensated amplitude M). The cosine orthogonality compensator 640 uses the corrected angle θcorr and the fully compensated sine/cosine signals to produce a fully compensated cosine signal. Both the fully compensated sine and cosine signals Sc, Cc are transported to the A TAN 2 function 660, which produces therefrom the compensated angle θcorr.

FIG. 7A is a simplified block diagram illustrating a non-limiting example of how the RSO compensation algorithm 420A (shown in FIG. 6) can be implemented as a RSO compensation algorithm 420B in accordance with embodiments of the disclosure. FIG. 7A depicts the RSO compensation algorithm 420B with reference numbers and various signals illustrated. FIG. 7B is identical to FIG. 7A except the reference numbers are omitted for ease of illustration; a dotted line box is drawn around the components (e.g., summer 702 and gain/integrator 706) of the RSO compensation algorithm 420B that can be used to implement a sine DC offset compensator 610A, which corresponds to the sine DC offset compensator 610 shown in FIG. 6; and a dotted line box is drawn around the components (e.g., summer 712 and gain/integrator 716) of the RSO compensation algorithm 420B that can be used to implement the cosine DC offset compensator 620 (shown in FIG. 6). FIG. 7C is also identical to FIG. 7A except the reference numbers are omitted for ease of illustration; a dotted line box is drawn around the components (e.g., multiplication function 704, summer 744, gain/integrator 746, a tan 2 function 736, a gain 742, and a “cos” function 750) of the RSO compensation algorithm 420B that can be used to implement the sine amplitude compensator 630 (shown in FIG. 6); and a dotted line box is drawn around the components (e.g., summer 720, multiplication function 714, gain/integrator 722, summer 732, u² function 730, and u² function 734) of the RSO compensation algorithm 420B that can be used to implement the cosine amplitude compensator 650 (shown in FIG. 6). FIG. 7D is also identical to FIG. 7A except the reference numbers are omitted for ease of illustration, and a dotted line box is drawn around the components (e.g., a summer 726, a multiplication function 724, gain/integrator 742, and a “sine” function 750) of the RSO compensation algorithm 420B that can be used to implement the cosine orthogonality compensator 640 (shown in FIG. 6).

The RSO compensation algorithm 420A (shown in FIG. 6), the explanations of the operations of the RSO compensation algorithm 420A provided herein, and the components and equations of the RSO compensation algorithm 420B (shown in FIGS. 7A-7D) provide sufficient details to enable a person skilled in the relevant arts to make and use the embodiments of the RSO compensation algorithm 420A depicted in FIGS. 7A-7D. Accordingly, the following description of the components and equations of the RSO compensation algorithm 420B will be provided at a higher level in the interest of brevity.

By way of introduction, the following general descriptions of components of the RSO compensation algorithm 420B with now be provided. The gain/integrator 706; the gain/integrator 716; the gain/integrator 722; the gain/integrator 746; and the gain/integrator 740 all corresponds to symbols depicted in FIG. 3. The “u²” block/function 730 represents a squaring function where the input signal is multiplied by itself twice. The “gain block with 2” at gain block 742 represents a multiplication function where the input signal is multiplied by 2. The “cos” block/function 750 represents the cosine trigonometric function where the input signal has its cosine calculated. The “sin” block/function 752 represents the sine trigonometric function where the input signal has its sine calculated.

With reference to FIGS. 7A-D, in accordance with aspects of the disclosure, each individual compensation task/component 610A, 620A, 630A, 650A, 640A of the RSO compensation algorithm 420B corresponds to one of the RSO error compensation segments/paths 122A-122C (shown in FIG. 1B) and so can be controlled and analyzed individually in substantially the same manner. For example, the microcontroller 410, 510 (shown in FIGS. 4 and 5) and/or the sensor diagnostics 140 (shown in FIG. 1A) can be used to individually evaluate the individual compensation task/component 610A, 620A, 630A, 650A, 640A of the RSO compensation algorithm 420B to generate the graphs 810, 820 shown in FIG. 8. In particular, graph 820 shows the time from when compensation performed by the individual compensation tasks/components 610A-650A is initiated (at zero seconds) and when the compensation performed by the individual compensation tasks/components 610A-650A has been completed (about 15 seconds). However, graph 810 shows how each individual compensation segment/path 610A-650A contributes to the time it takes from when compensation is initiated to when each compensation performed by the individual compensation tasks/components 610A-650A has been completed. As shown by graph 810, the compensation learned values Os (sine offset error), Ks (sine scaling error), and Kc (cosine scaling error) settle to a steady state (i.e., the error has been learned by its associated compensation segment/path and removed) relatively quickly (e.g., at about 15 seconds), while each of the other compensation learned values Oc (cosine offset error) and Ortho (sine and cosine orthogonality error) settle to a steady state faster. Responsive to the analysis reflected in graph 810, the microcontrollers 410, 510 can compute and apply adjustments to the relevant individual compensation tasks/components 610A-650A to speed up their compensation tasks so that they are completed in a time that is equal to or closer to the Oc compensation. One non-limiting example of an adjustment that can be applied to the relevant individual compensation tasks/components 610A-650A to speed up their compensation tasks is making an appropriate increase to the various gain/integrator functions 706, 716, 722, 740, 746 of the RSO compensation algorithm 420B.

With reference still to FIGS. 7A-D, in accordance with aspects of the disclosure, the main inputs to the RSO compensation algorithm 420B are an uncompensated sine RSO (Sr) and an uncompensated cosine RSO (Cr). As best shown in FIG. 7A, the function representing the uncompensated sine RSO (Sr) function includes error components shown as an amplitude A1 and an orthogonality error (Os); and the function representing the uncompensated cosine RSO (Cr) function includes error components shown as an amplitude A2 (which is not equal to A1), an orthogonality error (Oc), and an additional angular error (Φ). At the outputs of the RSO compensation algorithm 420B, the sine/cosine DC offset compensation segments/paths 610A, 620A have removed the sine/cosine offsets Os, Oc; the sine/cosign amplitude compensation segments/paths 610A, 620A have removed the amplitude errors in A1 and A2 by normalizing A1 and A2 to a chosen value of M; and the cosine orthogonality compensation segment/path 640A and the a tan 2 function 736 have removed the additional angular error (Φ) to generate θcorr. The outputs from the RSO compensation algorithm 420B are provided to other processing functionality (e.g., sensor diagnostics module 140 (shown in FIG. 1A) and/or the microcontrollers 410, 510 (shown in FIGS. 4 and 5) for performing the various analysis/diagnostic operations previously described herein. The outputs of the RSO compensation algorithm provide downstream processing flexibility by providing both Sc/Cc, which can be used directly by some types of downstream processing to begin conversation of Sc/Cc to angular position data, as well as θcorr, which can be used by other types of downstream processing to perform additional analysis on θcorr to generate its own version of Sc/Cc tailored for its particular application.

In some embodiments of the disclosure, the raw-error compensation operations performed by the five (5) raw-error compensation mechanisms 610-650 (shown in FIG. 5) can be configured as machine learning tasks, and the five (5) raw-error compensation mechanisms 610-650 can include machine learning algorithms configured and arranged to perform the raw-error compensation operations described herein as machine learning tasks. In general, machine learning techniques are run on so-called “neural networks,” which can be implemented as programmable computers configured to run sets of machine learning algorithms and/or natural language processing algorithms. Neural networks incorporate knowledge from a variety of disciplines, including neurophysiology, cognitive science/psychology, physics (statistical mechanics), control theory, computer science, artificial intelligence, statistics/mathematics, pattern recognition, computer vision, parallel processing and hardware (e.g., digital/analog/VLSI/optical).

The basic function of neural networks and their machine learning algorithms is to recognize patterns by interpreting unstructured sensor data through a kind of machine perception. Unstructured real-world data in its native form (e.g., RSO from the sensors 150, 450 and/or sensing element 250A) is converted to a numerical form (e.g., a vector having magnitude and direction) that can be understood and manipulated by a computer. The machine learning algorithm performs multiple iterations of learning-based analysis on the real-world data vectors until patterns (or relationships) contained in the real-world data vectors are uncovered and learned. The learned patterns/relationships function as predictive models that can be used to perform a variety of tasks, including, for example, classification (or labeling) of real-world data and clustering of real-world data. Classification tasks often depend on the use of labeled datasets to train the neural network (i.e., the model) to recognize the correlation between labels and data. This is known as supervised learning. Examples of classification tasks include identifying objects in images (e.g., stop signs, pedestrians, lane markers, etc.), recognizing gestures in video, detecting voices, detecting voices in audio, identifying particular speakers, transcribing speech into text, and the like. Clustering tasks identify similarities between objects, which the clustering task groups according to those characteristics in common and which differentiate them from other groups of objects. These groups are known as “clusters.”

FIG. 9 illustrates an example of a computer system 900 that can be used to implement the computer-based components (e.g., the controller 110) in accordance with aspects of the disclosure. The computer system 900 includes an exemplary computing device (“computer”) 902 configured for performing various aspects of the content-based semantic monitoring operations described herein in accordance aspects of the disclosure. In addition to computer 902, exemplary computer system 900 includes network 914, which connects computer 902 to additional systems (not depicted) and can include one or more wide area networks (WANs) and/or local area networks (LANs) such as the Internet, intranet(s), and/or wireless communication network(s). Computer 902 and additional system are in communication via network 914, e.g., to communicate data between them.

Exemplary computer 902 includes processor cores 904, main memory (“memory”) 910, and input/output component(s) 912, which are in communication via bus 903. Processor cores 904 includes cache memory (“cache”) 906 and controls 908, which include branch prediction structures and associated search, hit, detect and update logic, which will be described in more detail below. Cache 906 can include multiple cache levels (not depicted) that are on or off-chip from processor 904. Memory 910 can include various data stored therein, e.g., instructions, software, routines, etc., which, e.g., can be transferred to/from cache 906 by controls 908 for execution by processor 904. Input/output component(s) 912 can include one or more components that facilitate local and/or remote input/output operations to/from computer 902, such as a display, keyboard, modem, network adapter, etc. (not depicted).

A cloud computing system 50 is in wired or wireless electronic communication with the computer system 900. The cloud computing system 50 can supplement, support or replace some or all of the functionality (in any combination) of the computing system 900. Additionally, some or all of the functionality of the computer system 900 can be implemented as a node of the cloud computing system 50.

Many of the functional units of the systems described in this specification have been labeled as modules. Embodiments of the disclosure apply to a wide variety of module implementations. For example, a module can be implemented as a hardware circuit including custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like. Modules can also be implemented in software for execution by various types of processors. An identified module of executable code can, for instance, include one or more physical or logical blocks of computer instructions which can, for instance, be organized as an object, procedure, or function. Nevertheless, the executables of an identified module need not be physically located together but can include disparate instructions stored in different locations which, when joined logically together, function as the module and achieve the stated purpose for the module.

The various components/modules/models of the systems illustrated herein are depicted separately for ease of illustration and explanation. In embodiments of the disclosure, the functions performed by the various components/modules/models can be distributed differently than shown without departing from the scope of the various embodiments of the disclosure describe herein unless it is specifically stated otherwise.

Aspects of the disclosure can be embodied as a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The terms “about,” “substantially,” and equivalents thereof are intended to include the degree of error associated with measurement of the particular quantity based upon the equipment available at the time of filing the application. For example, “about” can include a range of ±8% or 5%, or 2% of a given value.

The term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made, and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure is not limited to the particular embodiment disclosed as the best mode contemplated for carrying out this present disclosure, but that the present disclosure will include all embodiments falling within the scope of the claims.

What is claimed is:

1. A system comprising a controller operable to execute controller operations comprising:
processing raw sensor output (RSO) to generate an error-compensated version of the RSO; and
generating state information based at least in part on the error-compensated version of the RSO;
wherein the state information is operable to convey a state of a target.

2. The system of claim 1 further comprising a smart sensor comprising a sensor element and the controller, wherein the sensor element is operable to generate the RSO.

3. The system of claim 1, wherein the controller operations further comprise using some or all of the state information to perform target control operations associated with the target.

4. The system of claim 1, wherein:
the RSO comprises a native variable format; and
the state information comprises a converted variable format.

5. The system of claim 1, wherein processing the RSO comprises learning aspects of error in the RSO.

6. The system of claim 5, wherein:
the aspects of error in the RSO comprise a first RSO-error factor; and
generating the error-compensated version of the RSO comprises matching the first RSO-error factor to a first RSO-error compensation processing path configured to compensate error associated with the first RSO-error factor.

7. The system of claim 6, wherein:
the aspects of the error in the RSO comprises a second RSO-error factor;
generating the error-compensated version of the RSO further comprises matching the second RSO-error factor to a second RSO error compensation processing path configured to compensate error associated with the second RSO-error factor; and
the first RSO error compensation processing path is different from the second RSO error compensation processing path.

8. The system of claim 7, wherein the aspects of the error of the RSO are selected from the group consisting of a cosine offset, a sine offset, a cosine amplitude, a sine amplitude, and an orthogonality error between a cosine signal and a sine signal.

9. The system of claim 1, wherein the controller operations further comprise performing error diagnostic operations based at least in part on learned RSO-error factors of the RSO.

10. The system of claim 9, wherein the error diagnostic operations further comprise determining a cause of the learned RSO-error factors of the RSO.

11. The system of claim 10, wherein the cause comprises an out-of-tolerance condition.

12. The system of claim 10, wherein the cause comprises a fault condition.

13. The system of claim 9, wherein:
the learned RSO-error factors of the RSO comprise a first RSO-error factor and a second RSO-error factor; and
the error diagnostic operations further comprise determining:
a cause of the first RSO-error factor of the RSO; and
a cause of the second RSO-error factor of the RSO.

14. A system comprising a controller operable to execute controller operations comprising:
processing raw sensor output (RSO) to generate an error-compensated version of the RSO; and
generating state information based at least in part on the error-compensated version of the RSO;
wherein processing the RSO comprises learning aspects of error in the RSO; and
wherein the state information is operable to convey an angular position of a rotor of a motor.

15. The system of claim 14, wherein the controller operations further comprise using some or all of the state information to perform control operations associated with the motor.

16. The system of claim 14, wherein:
aspects of error in the RSO comprise a first RSO-error factor; and
generating the error-compensated version of the RSO comprises matching the first RSO-error factor to a first RSO-error compensation processing path configured to compensate error associated with the first RSO-error factor.

17. The system of claim 16, wherein:
the aspects of the error in the RSO comprises a second RSO-error factor;
generating the error-compensated version of the RSO further comprises matching the second RSO-error factor to a second RSO error compensation processing path configured to compensate error associated with the second RSO-error factor; and
the first RSO error compensation processing path is different from the second RSO error compensation processing path.

18. The system of claim 17, wherein the aspects of the error in the RSO are selected from the group consisting of a cosine offset, a sine offset, a cosine amplitude, a sine amplitude, and an orthogonality error between a cosine signal and a sine signal.

19. The system of claim 14, wherein:
the controller operations further comprise performing error diagnostic operations based at least in part on the learned RSO-error factors of the RSO;
the learned RSO-error factors of the RSO comprise a first RSO-error factor and a second RSO-error factor; and
the error diagnostic operations further comprise determining:
a cause of the first RSO-error factor of the RSO; and
a cause of the second RSO-error factor of the RSO.

20. A method of forming a system, the method comprising:
providing a controller operable to execute controller operations comprising:
processing raw sensor output (RSO) to generate an error-compensated version of the RSO; and
generating state information based at least in part on the error-compensated version of the RSO; and
wherein the state information is operable to convey a state of a target.
